(19) United States
(12) Patent Application Publication
(10) Pub. No.: US 2008/0174045 A1
(43) Pub. Date: Jul. 24, 2008

(54) Apparatus and Process For the Formation of a Film Fibre

(75) Inventors: Johannes I. Tiesnitsch, Weert (NL); Matheus P. Quaedflieg, Kerkrade (NL); Leonardus W.G. Rijks, Holtum (NL); Laurentius J.H. Nijsten, Born (NL)

Correspondence Address: NIXON & VANDERHYE, PC, 901 NORTH GLEBE ROAD, 11TH FLOOR, ARLINGTON, VA, 22203, US

(73) Assignee: DSM IP ASSETS B.V., Heerlen (NL)

(21) Appl. No.: 11/579,868

(22) PCT Filed: May 4, 2005
(86) PCT No.: PCT/EP2005/004967

§ 371 Date: Jan. 30, 2008

(30) Foreign Application Priority Data
May 13, 2004 (EP) 04076421.9
Sep. 10, 2004 (EP) 04077513.2

(51) Int. Cl. B29C 55/00; B29C 55/02; B29C 69/00; B65H 75/34

(52) U.S. Cl. 264/291; 425/384; 425/383; 242/390.9

(57) ABSTRACT

The invention deals with an apparatus for the preparation of a film or fibre out of a reduced amount of material, in particular of polymeric material. This is achieved with small-sized equipment wherein each stretch roll has a diameter of between 35 and 100 mm. The invention also relates to a process for preparing a representative film from or fibre with a reduced amount of material, by using the specific equipment.

The present invention deals with and relates to an apparatus for the formation of a film or fibre, in particular a polymeric film or fibre. Such an apparatus (or equipment) comprises the following elements:
a) means for melting and shaping a material composition into a form suitable for the formation of a film or fibre,
b) means for cooling the melted and shaped material,
c) means for stretching the film or fibre.

The formation on a large scale of in particular polymeric films or polymeric fibres is a standard process in the polymer industry. A polymer composition (comprising a polymer, or a mixture of a polymer+added ingredients) is melted by heating the polymer composition to a temperature above its melting point (determined via a known technique as DSC (differential scanning calorimetry)), whereafter the melted material is shaped into a form suitable for the preparation of a polymeric film or polymeric fibre. In several cases this shaping is effected by forming the molten polymer composition through a so-called die. After the formation of the shaped polymer composition, the so-shaped material is cooled, and stretched over one or more stretching rolls, in order to form the final polymeric films or polymeric fibres.

The equipment present in the art is of such a design that one needs a substantial amount of feed of the polymeric composition in order to form the final film or fibre. This means that, especially in those situations wherein only a limited amount of the polymeric composition is available, it is impossible to test the properties of such a composition for film or fibre forming, nor the properties of the resulting film or fibre. This also influences polymer research in a laboratory environment, especially in those cases where catalytic and process parameters are to be tested. In those situations an only limited amount of polymer is produced within an acceptable time, as a result of which the quality of the so-produced polymer for film or fibre forming cannot be tested unless a certain mass production is undertaken. This is specifically the case in the so-called High-Throughput-Experimentation (HTE), where a fast screening of produced polymer samples is essential.

Therefore there is a need for a small-sized equipment, which can be used to form a polymeric film or polymeric fibre out of a limited amount of a polymeric material.

This problem is solved by an apparatus of the present invention, which apparatus is characterized by the fact that the apparatus comprises means to control the torque during the stretching down to 1.5*10⁻³ Nm, and wherein the rotational velocity of each stretch roll, having a diameter of between 35 and 100 mm, can be set between 0.25 and 35 RPM.

It has been found that, in order to obtain a representative film or fibre for a certain low amount of a polymer composition, it is not enough to reduce the dimension of the equipment (especially the diameter of the stretch roll(s)). There is also a need to reduce the torque during the take off and stretching (the conventional torque-values used in equipment of the prior art are in the order of 1 Nm and would result in a rupture of the film or of the fibre), as well as a need to reduce the rotational velocity of each stretch roll. Here and hereinafter the torque is determined with the following formula:

Torque (T)=M*g*r (Nm) (I),

in which:
M=mass of the film between an outlet of the extruder and a first roll or between a first and a second roll (in kg)
g=gravitation constant (in m/s²)
r=radius of the second (or downstream) roll (in m),
and indicates the maximum amount of polymer mass that can be worked without stopping the roll.

In order to obtain a uniform film, both in the length as well as in the width, it is preferred that the apparatus comprises means to supply cooling air in laminar flow to a location where the melted and shaped material is to be cooled. More preferred, the apparatus comprises means to supply the cooling air evenly over the length of the first roll.

The (polymeric) material preferably is a thermoplastic (polymeric) material. Non-polymeric materials may also be mixed with a component giving coherence to the material when cooled down, e.g. a binder.

In order to supply a reduced amount of (polymeric) material, the means for shaping the molten (polymeric) composition, which is, as indicated before, preferably in the form of a die, should also have a reduced size. The die can be of any shape, for instance, rectangular, round or square.

To be able to clean the die it comprises preferably at least 2 parts that can be separated to free the outlet of the die.

For shaping the molten (polymeric) composition into a film the die is preferably divided into a part A comprising at its broadest side one side of the outlet of the die and a part B comprising at its broadest side a cavity, shaped in such a way that the melt divides evenly towards the outlet of the die; one side of part B forming the other side of the outlet of the die.

Both parts of the die are attached to the extruder at the extremities, being the sides of the parts at the far ends of the outlet of the part, so that the outlet is formed by parts A and B. In this way a very good fixation of the die to the housing is obtained preventing the die from leaking at high pressure. An other advantage is that by this fixation it is possible to raise the width of the outlet to as broad as 200 mm. A third part C can be used that is attached to the extruder. Parts A and B are than attached to C. This gives one the opportunity to easily switch parts A and B or only part A to vary the height of the outlet. It is also possible to switch the whole die consisting of parts A, B and C when one wants to vary the height of the outlet. In this way switching can be done more quickly and part C protects the outlet of part A and the cavity of part B for damage. Part C also makes the total die more rigid and can be necessary when constructing dies with a width higher than 100 mm.

The die is attached to the extruder and the flow path that the melt describes in the die preferably has a Z-shape. In contrast with known dies, which have a straight flow path, the die with a Z-shaped flow path can be made thinner. Thinner here means that the distance between the extruder and the outlet of the die is as low as possible. The advantage of a thinner die is that the die needs not to be heated separately. The heat of the extruder whereto the die is attached is enough to keep the polymer melt above its melting temperature in the die.

The outlet in the die has a width of between 5 and 200 mm, preferably between 5 and 100 mm and more preferably between 5 and 70 mm.

The height of the outlet is generally between 0.05 and 1.0 mm, and preferably between 0.1 and 0.6 mm.

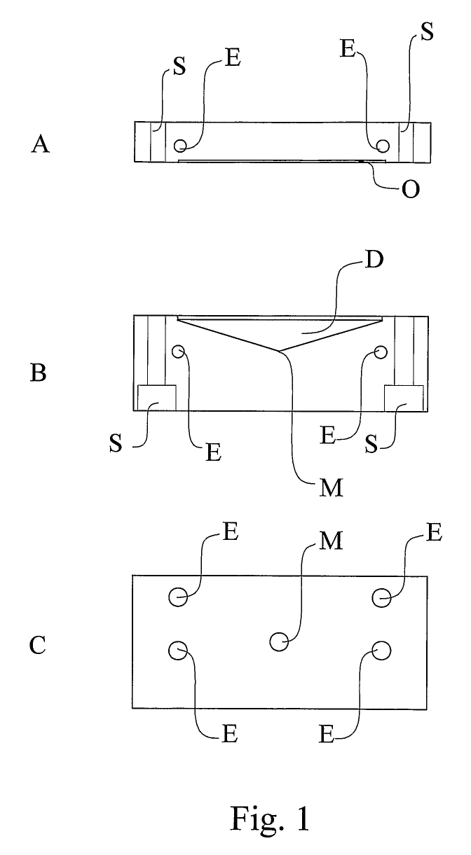

In FIG. 1 part A, part B and part C are shown. Part A comprising at its broadest side a cavity (o) of a depth determining the height of the outlet of the die when attached to part B as shown in the figure. By changing the part A for another part A with a cavity of another depth the height of the outlet can be varied.

Part B comprises at its broadest side a cavity, shaped in such a way that the melt divides evenly towards the outlet of the die. Part B shown in FIG. 1 has a cavity in the form of a coat hanger (d), but the cavity can also have other shapes, such as a half-round slit or a round coat hanger shape.

The polymer melt enters the die at the narrowest point of the coat hanger (m) and divides over the coat hanger towards the outlet. To enter the outlet it has to make a 90° turn. Preferably parts A and B are attached to each other with screws(s).

The parts A and B can also be attached to the extruder with screws (e) at the extremities of the parts. Other ways of attachment are also possible, for instance by sliding the die into a holder or rotating the die into a locked position by means of a so-called bajonet closure.

By attachment of the parts at the extremities, the parts have a good fixation to the extruder.

The melt enters the die at m and makes a turn of about 70° when entering the coat hanger cavity of part B. When entering the outlet again a turn of about 90° is made by the polymer melt. This is a kind of Z-shape.

Part C is designed as a cover plate for the parts A and B that makes the die in total more rigid. The polymer melt is introduced into part B through m in part C.

Part C is attached to the extruder and to parts A and B with screws at the points e.

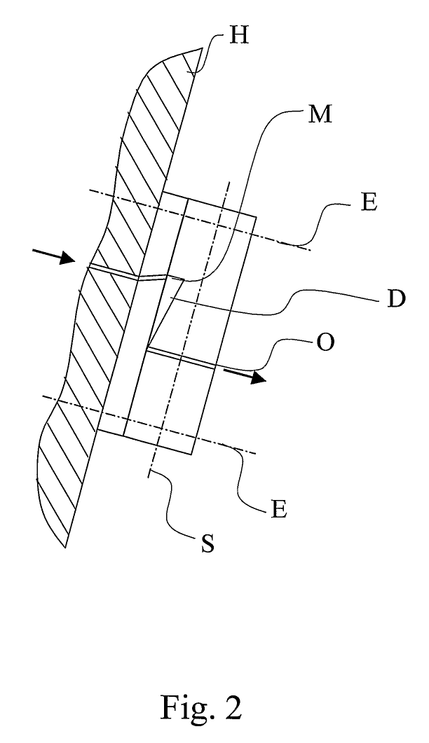

The totality of parts A, B and C fixed together is attached to the extruder (H) at the points e as shown in FIG. 2. In this figure also the Z-shape the polymer melt describes is clearly shown.

The die, suitable for the preparation of polymeric fibres, has one or more die-openings, each opening having a diameter of between 0.1 and 2.5 mm, more preferably a diameter of between 0.5 and 1.5 mm.

In order to be able to supply a reduced amount of polymeric material, the means for melting the polymer composition have to be adapted and suitable for that purpose. Therefore it is preferred that said means is an extruder, preferably a small sized extruder, such as sold as Micro-extruder by DSM Xplore, in sizes of 5 and 15 ml (see also WO 02/16481, page 48; and WO 00/47667, page 7).

The ideal situation for using the apparatus for the formation of a polymeric film or of polymeric fibres is that the rotational velocity of each stretch roll can be kept constant. The first stretch roll, also denoted as take-up roll, takes up the molten extrudate, e.g. in film or fibre form, from a common extruder and cooling it down to below its melting point. To rotate such rolls, in common industrial equipment direct current (d.c.) motors are applied. These motors have the advantage that they rotate with constant speed and are preferred since irregularities or variations in the rotational speed lead to corresponding irregularities and variations in the thickness of the cooled extruded film or fibre. However, the speed at which these d.c. motors can run cannot be decreased deliberately. The lowest speed at which these motors can run at constant speed is still higher than that corresponding to the allowable circumferential speed of the roll for taking up the molten extrudate from a micro-extruder, i.e. an extruder that produces amounts of molten extrudate as low as 0.03 g/min. Equipment to achieve such a goal on the small scale of the apparatus of the present invention is not available.

A further goal of the invention now is to provide a take-up roll system that can take up a molten extrudate at speeds as low as without causing irregularities in the thickness of the extrudate.

This goal is achieved in that the take up roll system comprising a roll having a diameter of between 35 and 100 mm and having a weight of between 0.2 and 2.0 kg, more typical between 0.5 and 1.0 kg, a stepper motor for rotating the roller with a circumferential speed of between 8.75 and 3500 mm/min, preferably of between 10 and 2000 mm/min or even less than 1000 mm/min, and means for controlling the stepper motor in a microstepping regime.

Surprisingly this system allows a molten film or fibre extruded with speeds lower than 3500 and even lower than 2000 mm/min or lower than 1000 m/min, to be taken up and cooled without causing thickness variations or irregularities in the film or fiber.

The choice of a stepper motor, which inherently shows irregularities (‘steps’) in its rotational motion, is in fact conflicting with the requirement of a constant rotational speed. However, it appeared that the combination of a micro-stepping motor with a roll having a properly chosen moment of inertia, is able to produce films with an even thickness at the required low speed.

The technique of microstepping as such is known in the art and brings about an intermittent rotation of the roll, wherein in small time-intervals a part of the rotation is preformed.

The width, i.e. its length measured along its axis of rotation, of each stretch roll is in general not greater than 150 mm but when wider dies e.g. up to 200 mm are applied the width of the rolls may be larger, also up to 200 mm. Preferably this width is between 10 and 75 mm. The last roll of the apparatus generally also functions as a so-called “drum winder” on which the final film or fibre are collected.

The invention also relates to an apparatus for forming a film from a melted and shaped polymeric material, said apparatus comprising at least two stretch rolls. This apparatus is characterized in that the rotational velocity of each stretch roll, having a diameter of between 35 and 100 mm, can independently be set between 0.25 and 35 RPM. In preference, in such an apparatus the second stretch roll has a rotational velocity automatically related to the rotational velocity of the first roll, and wherein the second roll has a torque of at least 1.5*10⁻³ Nm. In preference, the first roll is rotation-controlled, whereas the second (and consecutive) roll(s) are torque-controlled. In particular the first roll has a weight of between 0.2 and 2.0 kg, more typical between 0.5 and 1.0 kg and is driven by a stepper motor in a microstepping regime with a circumferential speed of between 8.75 and 3500 mm/min, preferably of between 10 and 2000 mm/min or even less than 1000 mm/min. The invention also relates to a process for the preparation of a polymeric film or a polymeric fibre from a polymeric composition by means of melting, shaping and cooling. As indicated above, a process for the preparation of a polymeric film or polymeric fibre from a reduced amount of a polymeric composition is absent in the art. By using an equipment according to the present invention this problem can be overcome, as in general an amount of up to 5-15 g./min. of polymeric material can be applied. More specific, in the present process the polymer composition is fed to the apparatus in a feed rate of between 0.03 and 250 g./min., and wherein the stretching rolls have a rotational velocity of between 0.25 and 35 RPM.

The polymer composition from which a polymeric film or polymeric fibre is to be made can comprise any polymer, which is melt processable (or thermoplastic). The skilled man is aware of such polymers.

The process is not only applicable for a polymer as such, but can also be applied to a mixture of a polymer and added ingredients, wherein said mixture can either be fed to the apparatus as such, or the mixture can be made during the melting and shaping process, preferably when this melting and shaping takes place in an extruder.

As polyethylene and polypropylene (either in the form of a homopolymer or in the form of a copolymer) is a frequently used polymer for the preparation of a polymeric film, these polymers are preferred ingredients for the present process.

Although the present apparatus and present process are described in detail for polymeric film or fibres, the apparatus and the process can also be used for the formation of a film or of fibres out of other material, like dough or inorganic metals (like aluminium). In relevant cases, the means for melting and cooling the composition to be transformed to a film or to fibres can, or need to be, omitted.

The cooling step in the process of the present invention is generally done by means of cooling with a gas, preferably done by means of cooling with air, which is supplied to a location when the melted and shaped material is cooled. In more preference, the cooling air is supplied evenly over the length of the first stretch roll; this in order to obtain a uniform polymer cooling process over the length of the shaped material. The temperature, to which the shaped polymeric material is cooled, is preferably below the crystallization point of the polymeric composition (said point being determined by a DSC-measurement).

When microstepping is applied to the stretch roll(s) in order to approximate a constant rotational velocity, the amplitude of the microsteps is such as to achieve a rotation of the roll, per step, of between 0.01-0.20°, more preferred of between 0.02-0.10°. This is in order to obtain a stable and representative film or fibre.

In order to transport the shaped polymer composition through the apparatus, a torque of at least 1.5*10⁻³ Nm has to be applied. The torque has also to be in a range as to avoid rupture of the resulting film or fibre. This range

In the process of the present invention an additional process step can be included, in which (heat-sensitive) ingredients can be added to the polymeric film or polymeric fibre, during or preferably after the cooling step of the present invention. By doing so, heat treatment (and thus heat-destruction) of such heat sensitive ingredients is avoided, or at least substantially avoided. This can be achieved by a process step, which as such is known in the art as “solvent crazing”: leading and stretching the polymeric film or polymeric fibre through a liquid bath, in which the heat-sensitive ingredient(s) are present. This can be any liquid, be it that the liquid is not a solvent for the polymer composition. Preferably water is used as the liquid. Examples of heat-sensitive ingredients which can be added according to such a process step are: vitamins, medicines, and alike in the food, feed, and pharmaceutical industry.

As a result of the present invention an apparatus and a process are made available for preparing a representative polymeric film or polymeric fibre from a reduced amount of polymeric material, said film or fibre having a conventional thickness, as practised in the art. In general, with the process and the apparatus of the present invention, films can be made with a final thickness up to 1 mm. Preferably, films can be made available with a final thickness of between 2 and 200 μm. Fibres preferable can be made with a final thickness of between 0.1 and 2.5 mm.

The invention will be illustrated by the following non-limiting, Examples.

Example I:

| Extruder: | DSM Xplore Micro-extruder 15 ml; | |
|---|---|---|
| | Parameters: | Speed: 5 rpm. |
| | | Temperature: 220° C. |
| Die used: | DSM Xplore Film die | |
| | Parameters: | Width: 19 mm |
| | | Height: 0.2 mm |
| Film forming device: | DSM Xplore Film device. | |
| | Parameters: | two stretch rolls |
| | | diameter roll: 75 mm |
| | | length roll: 58 mm |
| | | Speed: 1000 mm/min. |
| | | Torque: 22 * 10⁻³ Nm |
| | | Distance to die: 15 mm. |

| | |
|---|---|
| Air knife: | air temp: 20° C. |
| | air pressure: 1.6 bar |

| | |
|---|---|
| Product: | Polypropylene |
| | Quantity: 15 gr. |
| | Throughput: 0.341 gr/min |
| Result: | Film of 25 μm, uniform thickness. |

Example II:

| Extruder: | DSM Xplore Micro-extruder 15 ml; | |
|---|---|---|
| | Parameters: | Speed: 20 rpm. |
| | | Temperature: 280° C. |
| Die: | DSM Xplore Filmdie | |
| | Parameters: | Width: 19 mm |
| | | Height: 0.4 mm |
| Film forming device: | DSM Xplore Film device. | |
| | Parameters: | Two stretch rolls |
| | | Diameter roll: 75 mm. |
| | | Length roll: 58 mm. |
| | | Speed: 500 mm/min. |
| | | Torque: 34 * 10⁻³ Nm |
| | | Distance to die: 15 mm. |

| | |
|---|---|
| Air knife: | air temp: 20° C. |
| | air pressure: 1.2 bar |

| | |
|---|---|
| Product: | Nylon 6 |
| | Quantity: 15 gr. |
| | Throughput: 1.365 gr/min |
| Result: | Film of 200 μm, uniform thickness. |

Example III:

| Extruder: | DSM Xplore Micro-extruder 5 ml; | |
|---|---|---|
| | Parameters: | Speed: 2 rpm. |
| | | Temperature: 200° C. |
| Die: | DSM Xplore Filmdie | |
| | Parameters: | Width: 19 mm |
| | | Height: 0.2 mm |
| Film device: | DSM Xplore Film device. | |
| | Parameters: | Speed 750 mm/min. |
| | | Torque: 9 * 10⁻³ Nm |
| | | Distance to die: 15 mm. |

| | |
|---|---|
| Air knife: | air temp: 20° C. |
| | air pressure: 1.8 bar |

| | |
|---|---|
| Product: | Polyethylene. |
| | Quantity: 5 gr. |
| | Throughput: 0.051 gr/min |
| Result: | Film of 5 μm, uniform thickness. |

1. Apparatus for the formation of a film or polymeric fibre, comprising the following elements:
a. means for melting and/or for shaping a composition into a form suitable for the formation of a film or fibre,
b. means for cooling the melted and shaped material,
c. means for stretching the film or fibre, comprising a first and a second stretch roll characterized in that the apparatus comprises means to control the torque during the stretching down to 1.5*10³ Nm, and wherein the rotational velocity of each stretch roll, having a diameter of between 35 and 100 mm, can be set between 0.25 and 35 RPM.

2. Apparatus according to claim 1, wherein means are present to supply cooling air in laminar flow to a location where the melted and shaped material is to be cooled.

3. Apparatus according to claim 1, wherein the rotational velocity is controlled by micro-stepping.

4. Apparatus according to claim 1, wherein the means for shaping the material composition into a form suitable for the formation of a film is a die comprising at least 2 parts.

5. Apparatus according to claim 4, wherein the die is divided in a part A comprising at its broadest side one side of the outlet of the die and a part B comprising at its broadest side a cavity, shaped in such a way that the melt divides evenly towards the outlet of the die; one side of part B forming the other side of the outlet of the die.

6. Apparatus according to claim 1, wherein both parts of the die are attached to the extruder at the extremities of the part so that parts A and B form the outlet.

7. Apparatus according to claim 4, wherein the die is attached to the extruder and the flow path that the melt describes in the die has a Z-shape.

8. Apparatus for forming a film or a fibre from a melted and shaped material, said apparatus comprising at least two stretch rolls, characterized in that the rotational velocity of each stretch roll, having a diameter of between 35 and 100 mm, can independently be set between 0.25 and 35 RPM.

9. Process for the preparation of a film or fibre from a material composition by means of melting, shaping and cooling, characterized in that an apparatus is used according to claim 1.

10. Process according to claim 9, wherein the material composition is fed to the apparatus in a feed rate of between 0.03 and 250 g./min., and wherein the stretching rolls have a rotational velocity of between 0.25 and 35 RPM.

11. Process according to claim 9, wherein the material composition comprises a polyethylene or polypropylene homo- or copolymer.

12. Process according to claim 9, wherein the film is subjected to solvent crazing.

13. Process according to claim 9, wherein the material is a polymeric material.

14. Take-up roll system for use in an apparatus according to claim 1, comprising a roll having a diameter of between 35 and 100 mm and having a weight of between 0.2 and 2.0 kg, a stepper motor for rotating the roller with a circumferential speed of between 8.75 and 3500 mm/min, and means for controlling the stepper motor in a micro-stepping regime.

15. Take-up system according to claim 14, wherein the circumferential speed is between 50 and 2000 mm/min.
